(19) United States
(12) Patent Application Publication
(10) Pub. No.: US 2020/0284627 A1
(43) Pub. Date: Sep. 10, 2020

(54) FLOWMETER

(71) Applicant: TOFLO CORPORATION, Hino-shi, Tokyo (JP)

(72) Inventors: Takahiro KAWAMOTO, Hino-shi, Tokyo (JP); Takuo SHIMADA, Hino-shi, Tokyo (JP); Shinji TOBIMATSU, Hino-shi, Tokyo (JP); Tetsuaki SEKINE, Hino-shi, Tokyo (JP)

(21) Appl. No.: 16/644,994

(22) PCT Filed: Sep. 7, 2017
(86) PCT No.: PCT/JP2017/032374

§ 371 Date: Mar. 6, 2020

(51) Int. Cl. G01F 1/115

(52) U.S. Cl. CPC G01F 1/1155

(57) ABSTRACT

A flowmeter that achieves both high reliability and a low cost is provided. The flowmeter includes an impeller that is rotatably supported in a flow path, a magnetic sensor that detects a magnetic change associated with a rotation of the impeller, and a magnet that applies a magnetic field to the magnetic sensor, wherein the impeller is formed of a magnetic material that is not magnetized, and the magnetic sensor and the magnet are arranged outside the flow path.

### TECHNICAL FIELD

The present invention relates to an impeller-type flowmeter that measures a flow rate of a fluid flowing through a flow path based on a rotation speed of an impeller.

### BACKGROUND

For example, Patent Document 1 discloses a hot water supply apparatus that includes: a flow rate regulating valve that regulates a flow rate of water flowing through a water supply pipe; an impeller that is provided in a flow path communicatively connected to the flow rate regulating valve and has a magnet arranged on an outer periphery thereof and a flow rate sensor that is fixed to an outer wall of the flow path and measures a rotation speed of the impeller. In the hot water supply apparatus, the flow rate sensor converts a magnetic change associated with rotation of the impeller into a pulse signal, and a controller calculates the flow rate of the water based on the pulse signal (rotation speed signal) output from the flow rate sensor.

In general, for an impeller of a flow rate sensor, in order to ensure sufficient wear resistance, high hardness steel, ceramics, or the like is used as a material of a rotation shaft thereof. Further, since wing parts (blades) each have a complicated shape, an impeller is manufactured by insert-injection molding a plastic material mixed with a magnetic powder to mold the wing parts together with the rotation shaft, and further magnetizing the wing parts integrally molded with the rotation shaft. Then, a flowmeter equipped with such an impeller detects, for example, a change in magnetic flux density associated with rotation of the impeller by using a Hall element, and measures a rotation speed of the impeller based on a result of the detection. Further, a flow rate of a fluid flowing through the flow path is calculated from the rotation speed of the impeller by an arithmetic device.

### RELATED ART

### [Patent Doc. 1] JP Laid-Open Patent Application Publication 2007-46816

### [Patent Doc. 2] JP Laid-Open Patent Application Publication 2009-229099

### SUMMARY OF THE INVENTION

### Subject(s) to be Solved by the Invention

In such a flowmeter, since the wing parts (blades) of the impeller are magnetized, for example, when the fluid flowing through the flow path contains an iron powder, the iron powder adheres to the wing parts. In this case, the iron powder accumulates on the wing parts, preventing smooth rotation of the impeller. As a result, there is a problem that an error in the measurement of the flow rate becomes large, and reliability of the device is decreased. Further, in order to improve accuracy of the wing parts, conventionally, an impeller is manufactured by cut-machining. However, there is a problem that a manufacturing cost is significantly increased.

On the other hand, Patent Document 2 discloses a technology for removing an iron powder and other undesired substances adsorbed on blades of a flowmeter. In this flowmeter, protruding parts opposing magnetic poles of a rotating body are provided on an inner circumferential surface of a pipe conduit, and undesired substances such as an iron powder adsorbed on the magnetic poles collide with the protruding parts and are removed from the magnetic poles. However, although this method can remove undesired substances such as an iron powder to some extent, the undesired substances accumulate on the magnetic poles until a thickness is reached at which collision with the protruding parts occurs. That is, the impeller is a permanent magnet, and front ends of the blades are magnetized to form magnetic poles, and thus, adsorption of an iron powder or the like cannot be completely eliminated, and a fundamental solution to the above problem has not been achieved.

Therefore, the present invention is accomplished in view of such a situation, and is intended to provide a flowmeter that achieves both high reliability and a low cost.

### Means to Solve the Subject(s)

A flowmeter disclosed in the application includes an impeller that is rotatably supported in a flow path, a magnetic sensor that detects a magnetic change associated with a rotation of the impeller, and a magnet that applies a magnetic field to the magnetic sensor, wherein the impeller is formed of a magnetic material that is not magnetized, and the magnetic sensor and the magnet are arranged outside the flow path.

In the flowmeter of this invention, a rotation shaft and multiple wing parts that configure the impeller may be integrally molded.

In the flowmeter of this invention, the rotation shaft and the multiple wing parts are integrally molded by metal injection molding in which a magnetic material, which is not magnetized, is used as a material.

### Advantages of the Invention

According to the present invention, the impeller is formed of non-magnetized magnetic material, and the magnetic sensor and the magnet are arranged outside the flow path, and thereby, even when a fluid flowing through the flow path contains an iron powder, the iron powder does not adhere to and accumulate on the impeller, and smooth rotation of the impeller is not hindered. Therefore, sufficient measurement accuracy of the flowmeter is ensured. Further, the rotation shaft and the multiple wing parts of the impeller are integrally molded, and thereby, there is no need to join together the rotation shaft and the multiple wing parts, and thus, reliability of the impeller can be increased. Further, the rotation shaft and the multiple wing parts are integrally molded by metal injection molding in which a non-magnetized magnetic material is used as a material, and thereby, an impeller having a complicated shape can be molded with high precision. Therefore, a flowmeter that achieves both high reliability and a low cost can be provided.

### BRIEF DESCRIPTION OF THE DRAWINGS

FIGS. 1A-1C are respectively a top view, a front cross-sectional view and a bottom view of a flowmeter according to the present embodiment.

FIG. 2 illustrates a plan view and a side view of an impeller in the flowmeter illustrated in FIGS. 1A-1C.

FIG. 3 is a cross-sectional view of a flow rate control device to which the flowmeter of FIGS. 1A-1C is applied, and, in particular, is a cross-sectional view in a plane including an axis line of a flow path and an axis line of a ball shaft.

### DETAILED DESCRIPTION OF THE PREFERRED EMBODIMENT(S)

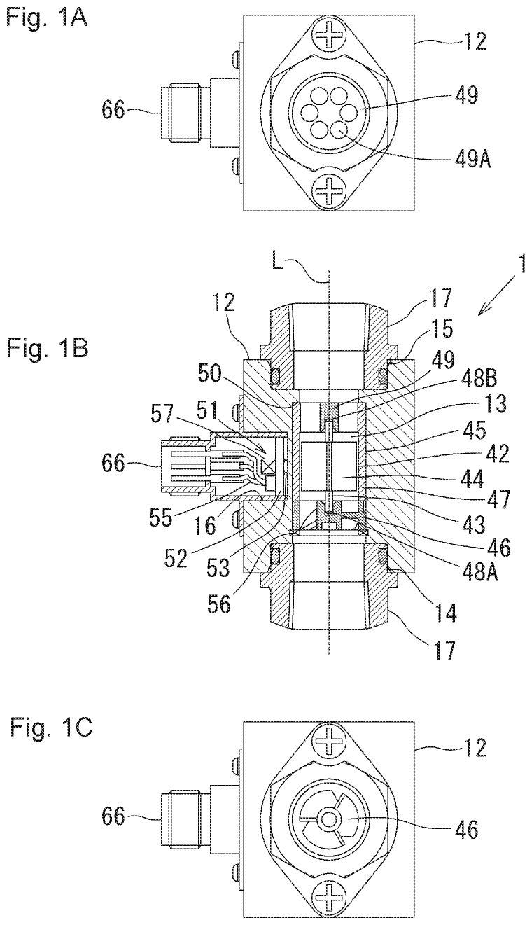

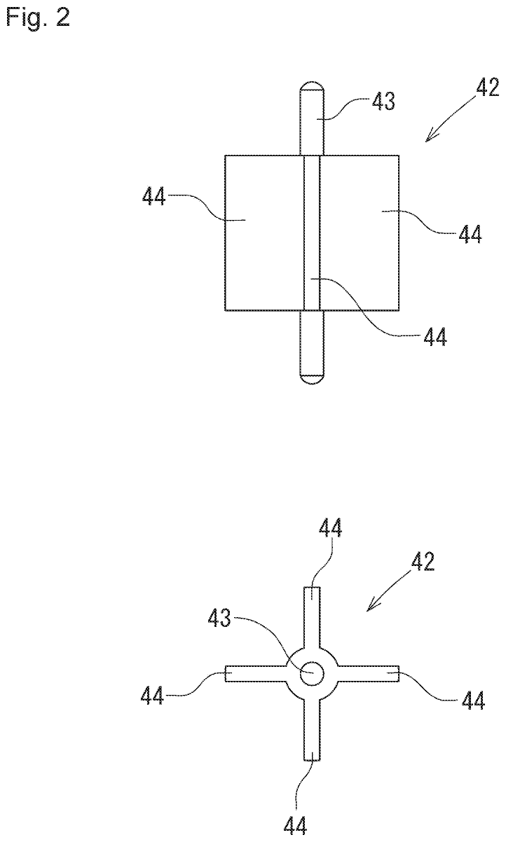

First, an embodiment of a flowmeter 1 of the present invention is described with reference to FIGS. 1A-1C and 2. For convenience, an up-down direction in FIGS. 1A-1C is defined as an up-down direction of the flowmeter 1.

As illustrated in FIGS. 1A-1C, the flowmeter 1 has a body 12 that is formed of plastic or a non-magnetic metal, and a flow path 13 that extends inside the body 12 in the up-down direction and through which a fluid (water) flows upward. The body 12 has an inlet 14 that opens at a lower end of the body 12 and to which an adapter 17 is connected (fitted), and an outlet 15 that opens at an upper end of the body 12 and to which an adapter 17 is connected (fitted). In each of the adapters 17, a pipe tapered screw for connecting a pipe connector is formed.

The flowmeter 1 of the present embodiment is a so-called impeller-type (turbine-type) flowmeter that indirectly measures a flow rate of a fluid flowing through the flow path 13 based on a rotation speed of an impeller 42, and has the impeller 42 and a supporting frame 45 that rotatably supports the impeller 42. The impeller 42 is formed of a non-magnetized magnetic material, and, as illustrated in FIG. 2, has a rotation shaft 43 that is arranged on an axis line L (see FIG. 1B) of the flow path 13 and multiple (four in the present embodiment) wing parts 44 (turbine blades) that are provided at equal intervals around the rotation shaft 43. In manufacturing the impeller 42 of the present embodiment, metal injection molding (MIM) in which a metal powder of a non-magnetized magnetic material is used as a material is applied, and the rotation shaft 43 and the multiple wing parts 44 are integrally (simultaneously) molded. As the material (magnetic material) of the metal injection molding, for example, a magnetic stainless steel (such as SUS630) is used.

As illustrated in FIGS. 1A-1C, the supporting frame 45 is configured by being divided into a swirling flow plate 46 that generates a swirling flow in a flowing-in fluid, a sleeve 47 that surrounds the wing parts 44 of the impeller 42, and a rectifier plate 49 that rectifies a flow of a flowing-out fluid. The swirling flow plate 46 is formed of plastic or a non-magnetic metal, and a bearing part 48A supporting a lower end of the rotation shaft 43 of the impeller 42 is provided at a center of the swirling flow plate 46. The sleeve 47 and the rectifier plate 49 are each formed of plastic or a non-magnetic metal; a bearing part 48B supporting an upper end of the rotation shaft 43 of the impeller 42 is provided at a center of the rectifier plate 49; and multiple circular holes 49A are formed on the same circumference. An upper end of the supporting frame 45 (sleeve 47) is abutted against a step part 50 formed in the flow path 13, and thereby, the supporting frame 45 (sleeve 47) is positioned in the up-down direction, that is, a direction along the axis line L of the flow path 13. Further, the supporting frame 45 (swirling flow plate 46) is prevented from moving downward (toward an upstream side) by a metallic C-shaped retaining ring 56 installed on an inner periphery of the flow path 13.

On the other hand, the flowmeter 1 has a sensor unit 51 that measures a rotation speed of the impeller 42. The sensor unit 51 includes a sensor substrate 52, a GMR (giant magnetoresistance) sensor 53 mounted on the sensor substrate 52, and a bias magnet 57 (for example, a ferrite bulk magnet) that applies a bias magnetic field to the GMR sensor 53, and is arranged outside the supporting frame 45 that forms the flow path 13. That is, the sensor unit 51 is accommodated inside a waterproof connector 66 attached to a recess part 16 of the body 12, and thereby, is completely isolated from the flow path 13 through which a fluid flows. Then, the sensor unit 51 measures a rotation speed of the impeller 42 based on a change in magnetic field strength associated with the rotation of the impeller 42 detected by the GMR sensor 53, and outputs to the outside via the waterproof connector 66 a pulse signal (for convenience, referred to as a “rotation speed signal”) corresponding to a result of the measurement.

In the present embodiment, the GMR sensor 53 is configured such that two GMR elements are arranged on the sensor substrate 52 at an interval in a rotation direction of the impeller 42 (sight directions in FIGS. 1A and 1B) to form a Wheatstone bridge, and a change in magnetic field strength is detected based on changes in resistance values of the two GMR elements. Further, a reference numeral “55” in FIG. 1B denotes a signal cable that connects the sensor substrate 52 to a connector terminal of the waterproof connector 66.

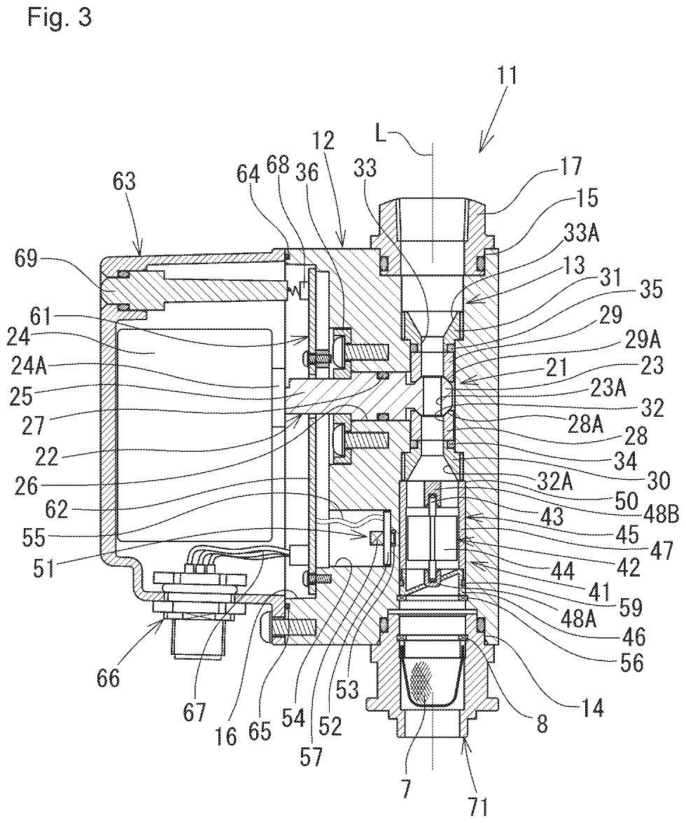

Next, with reference to FIG. 3, a flow rate control device 11 incorporating therein the flowmeter 1 having the above-described configuration is described. For convenience, an up-down direction in FIG. 3 is defined as an up-down direction of the flow rate control device 11.

As illustrated in FIG. 3, the flow rate control device 11 has a body 12 that is formed of plastic or a non-magnetic metal, and a flow path 13 that extends inside the body 12 in the up-down direction and in which a fluid (water) flows upward. The body 12 has an inlet 14 that opens at a lower end of the body 12 and to which a joint adapter 71 is connected, and an outlet 15 that opens at an upper end of the body 12 and to which an adapter 17 is connected (fitted). Here, for convenience, a flow path from the inlet 14 to the outlet 15 of the body 12 is referred to as the flow path 13. In the adapter 17, a pipe tapered screw for connecting a pipe connector is formed.

(Flow Rate Regulating Valve)

The flow rate control device 11 has a flow rate regulating valve 21 formed by a ball valve mechanism. The flow rate regulating valve 21 has a valve body 22 that includes a shaft part 25 and a ball part 23, the ball part 23 being provided on a front end (right end in FIG. 3) of the shaft part 25 and capable of blocking the flow path 13. A base end (left end in FIG. 3) of the shaft part 25 is connected to a rotation shaft 24A of a motor actuator 24. In the body 12, a shaft hole 26 is formed that penetrates the body 12 in a horizontal direction (left-right direction in FIG. 3) and communicatively connects to the flow path 13. The shaft part 25 of the valve body 22 is slidably fitted in the shaft hole 26. An O-ring 27 seals between the shaft part 25 of the valve body 22 and the shaft hole 26 of the body 12. Further, the motor actuator 24 includes a stepping motor, a speed reduction mechanism, and a position detecting sensor.

The flow rate regulating valve 21 has a pair of ball packings 28 and 29 that are respectively arranged on an upstream side and a downstream side of the flow path 13 sandwiching the ball part 23 of the valve body 22. The ball packing 28 on the upstream side is pressed toward a downstream side (upward in FIG. 3) by a fixing nut 30, and thereby, a valve seat part 28A is slidably in close contact with the ball part 23. Further, the ball packing 29 on the downstream side is pressed toward an upstream side (downward in FIG. 3) by a fixing nut 31, and thereby, a valve seat part 29A is slidably in close contact with the ball part 23. Here, FIG. 3 illustrates a state in which the flow rate regulating valve 21 is fully opened. In this state, an axis line of a flow path 23A of the ball part 23 of the valve body 22 coincides with an axis line of a flow path 32 extending through the ball packing 28 and the fixing nut 30 and coincides with an axis line of a flow path 33 extending through the ball packing 29 and the fixing nut 31, and, by extension, coincides with an axis line L of the flow path 13.

The flow path 32 has a diameter-reducing part 32A at an end part thereof on an opposite side (lower side in FIG. 3) with respect to the ball part 23 side (valve seat part 28A side) where a flow path area of the diameter-reducing part 32A gradually decreases. Further, the flow path 33 has a diameter-increasing part 33A at an end part thereof on an opposite side (upper side in FIG. 3) with respect to the ball part 23 side (valve seat part 29A side) where a flow path area of the diameter-increasing part 33A gradually increases. Further, an O-ring 34 seals between the fixing nut 30 and the flow path 13. Further, an O-ring 35 seals between the fixing nut 31 and the flow path 13. Further, a reference numeral “36” in FIG. 3 denotes a retaining plate that prevents movement of the valve body 22 in an axis line direction (left-right direction in FIG. 1) with respect to the shaft hole 26. Further, a reference numeral “59” in FIG. 3 denotes an O-ring that seals between the swirling flow plate 46 and the sleeve 47.

The flow rate control device 11 includes a control part 61 that feedback-controls opening of the flow rate regulating valve 21 based on a measurement result (rotation speed of the impeller 42) of a flow rate measurement part 41 formed of the flowmeter 1. The control part 61 is a so-called microcomputer that includes an arithmetic part, a storage part, and the like, and feedback-controls (PID-controls) the opening of the flow rate regulating valve 21 based on a rotation speed signal output from the flow rate measurement part 41 (a flow rate measured by the flow rate measurement part 41). That is, the control part 61 converts a rotation speed signal into a flow rate measurement value. In other words, the control part 61 converts a rotation speed into a flow rate based on a data table, and arithmetically processes the measured value (flow rate measurement value) and a set value (flow rate target value). Then, based on a result of the arithmetic processing, the control part 61 controls the motor actuator 24 to rotate the valve body 22, and hence the ball part 23, and adjusts the flow rate of the fluid flowing through the flow path 13.

The control part 61 has a control substrate 62 accommodated in a recess part 16 formed on one side (left side in FIG. 3) of the body 12. A housing 63 that is formed of an aluminum alloy and accommodates the motor actuator 24 is provided on the one side of the body 12, and a space between the housing 63 and the recess part 16 is sealed by a packing 64. The packing 64 is fitted in a packing groove 65 formed on a peripheral edge of the recess part 16 of the body 12. Further, a waterproof connector 66 used for communication with the outside (“RS485” in the present embodiment) is attached to a lower portion of the housing 63. Further, the waterproof connector 66 and the control substrate 62 are connected to each other by a signal cable 67 (a five-core cable in the present embodiment). Further, a reference numeral “68” in FIG. 3 denotes an LED (full color) mounted on the control substrate 62. Further, a reference numeral “69” in FIG. 3 denotes a light transmission window formed of a transparent resin for visually confirming the LED 68 from the outside.

(Operation)

Referring to FIG. 3, a fluid (“water” in the present embodiment) to be controlled passes through a filter 7 in the joint adapter 71 and is introduced into the flow path 13 from the inlet 14. The fluid flowing through the flow path 13 becomes a swirling flow that swirls in a certain direction by passing through the swirling flow plate 46. The swirling flow rotates the impeller 42 arranged in the flow path 13. The sensor unit 51 detects with the GMR sensor 53 a change in magnetic field strength associated with the rotation of the impeller 42, and measures the rotation speed of the impeller 42 based on the change in magnetic field strength. Then, the sensor unit 51 outputs a rotation speed signal (pulse signal) as a flow rate measurement result of the flow rate measurement part 41 to the control part 61.

The control part 61 converts the received rotation speed signal into a flow rate measurement value, and arithmetically processes the measured value (flow rate measurement value) and a set value (flow rate target value). Such a arithmetically processing is termed as PID processing. The control part 61 outputs a control signal corresponding to a result of the arithmetic processing to the motor actuator 24. As a result, the motor actuator 24 receives the control signal from the control part 61 and operates, and the opening of the flow rate regulating valve 21 (ball valve), that is, the flow path area of the flow path 13 is adjusted, and hence, the flow rate of the fluid flowing through the flow path 13 is adjusted.

### Effects

According to the present embodiment, the impeller 42 of the flow rate measurement part 41 was manufactured by metal injection molding in which an unmagnetized magnetic material is used as a material. Therefore, the impeller 42 having a complicated shape can be molded with high precision. Further, a manufacturing cost thereof can be significantly reduced as compared to a cut-machined impeller. As a result, the rotation shaft 43 and the multiple wing parts 44 of the impeller 42 can be integrally molded, and the number of parts can be reduced as compared to an impeller of which a rotation shaft 43 and multiple wing parts 44 are separately manufactured. Further, for an impeller manufactured by joining (press-fitting, bonding or the like) a rotation shaft 43 and multiple wing parts 44 instead of cut-machining in order to reduce a manufacturing cost, there is a problem that stricter quality control is required due to a decrease in reliability of joining parts. However, for the impeller 42 according to the present embodiment, by applying metal injection molding, such a problem can be solved.

Further, in the present embodiment, a magnetic stainless steel (magnetic material) as a non-magnetized magnetic material is used as the material of the impeller 42, and a change in magnetic field strength associated with the rotation of the impeller 42 is detected by the bias magnet 57 and the GMR sensor 53 arranged outside the flow path 13, and thereby, the flow rate of the fluid flowing through the flow path 13 is detected. Therefore, for example, even when an iron powder is contained in the fluid, the impeller 42 in the flow path 13 is not magnetized, and thus, unlike a magnetic impeller in which wing parts 44 (blades) are magnetized, the iron powder does not adhere to and accumulate on the impeller 42, and smooth rotation of the impeller 42 is not hindered. As a result, sufficient measurement accuracy of the flow rate measurement part 41 can be ensured, and hence, reliability of the flow rate control device 11 can be improved.

Further, in the present embodiment, the control substrate (control substrate 62) is accommodated in the closed housing 63. Therefore, the flow rate control device 11 can be reduced in size. Further, an aluminum alloy having excellent heat dissipation performance is used as the material of the housing 63. Therefore, for example, a flow rate of a fluid of a relatively high temperature can be controlled. Further, the light transmission window 69 for visually confirming the LED 68 (full color) is provided on a surface of the housing 63. Therefore, filter clogging, a sensor abnormality or the like can be visually confirmed from the outside.

### LEGENDS

1: flowmeter
13: flow path
41: flow rate measurement part
42: impeller
43: rotation shaft
44: wing part
53: GMR sensor
57: bias magnet

What is claimed is:

1. A flowmeter, comprising:
an impeller that is rotatably supported in a flow path;
a magnetic sensor that detects a magnetic change associated with a rotation of the impeller; and
a magnet that applies a magnetic field to the magnetic sensor, wherein
the impeller is formed of a magnetic material that is not magnetized, and
the magnetic sensor and the magnet are arranged outside the flow path.

2. The flowmeter according to claim 1, wherein
a rotation shaft and multiple wing parts that configure the impeller are integrally molded.

3. The flowmeter according to claim 2, wherein
the rotation shaft and the multiple wing parts are integrally molded by metal injection molding in which a magnetic material, which is not magnetized, is used as a material.
